(19) United States
(12) Patent Application Publication
(10) Pub. No.: US 2015/0355084 A1
(43) Pub. Date: Dec. 10, 2015

(54) OPTIMIZING ANALYSIS AND IDENTIFICATION OF PARTICULATE MATTER

(71) Applicant: UNIVERSITY OF CALIFORNIA, Berkeley, CA (US)

(72) Inventor: Richard M. White, Berkeley, CA (US)

(73) Assignee: UNIVERSITY OF CALIFORNIA, BERKELEY, CA (US)

(21) Appl. No.: 14/653,788

(22) PCT Filed: Dec. 18, 2013
(86) PCT No.: PCT/US13/76241

§ 371 Date: Jun. 18, 2015

Related U.S. Application Data
(60) Provisional application No. 61/739,660, filed on Dec. 19, 2012.

(51) Int. Cl. G01N 21/3563; G01N 15/14

(52) U.S. Cl. CPC G01N 21/3563; G01N 15/1434; G01N 2201/062; G01N 2201/06113

(57) ABSTRACT

An apparatus for analyzing and identifying sensed particulate matter may include, in one embodiment, a collection area attached to a portable electronic communication device. The collection area receives particulate matter from the external environment. A positioning element positions the particulate matter within the collection area to optimize placement of the particulate matter for optical inspection. An identification element illuminates and inspects the particulate matter to harvest data therefrom. The data includes, for example, optical characteristics of the particulate matter in a micrometer range. Finally, a software element compares the data to a library of stored data associated with various sources of particulate matter. The origin of the particulate matter under test is identified based on the comparison.

### RELATED U.S. APPLICATION

This application claims the benefit of U.S. Provisional Patent Application No. 61/739,660, entitled “Means For Identifying Sensed Particle Matter”, filed Dec. 19, 2012, which is incorporated herein in its entirety.

### BACKGROUND

This invention relates to apparatus and methods for analyzing and identifying particulate matter, and particularly to apparatus and methods for optimizing particulate matter collection, analysis, identification, and release processes.

Airborne particulate matter pollutants are small solid particulates or liquid droplets suspended in the atmosphere to form an aerosol. These may include, for example, diesel exhaust, tobacco smoke, volcanic ash, pollen, and house dust, including human skin flakes.

Particulate matter pollutants have diameters ranging from many tens of microns down to a few nanometers. Particulate matter pollutants measuring 2.5 microns in diameter or less (PM_{2.5}) are particularly harmful to humans as they may penetrate deep into respiratory systems, and may even get into the bloodstream. In fact, studies show a connection between particulate matter pollutants and respiratory and cardiac problems such as aggravated asthma, irregular heartbeat, and premature death in people with reduced heart or lung functionality.

One class of particulate matter pollutants, pollen grains, have diameters ranging from roughly twenty (20) to eighty (80) micrometers. Such grains are too large to be respired into lung airways or the tracheobronchial region. However, for some pollens, smaller portions of the grains have been identified as allergenic and can be distributed in the atmosphere independent of their parent grains. Ragweed pollen grains, for example, are relatively spherical, ranging in size between 19-20 micrometers in diameter. Their allergenic portions, which can detach from the grain and produce allergic reactions, range in diameter from 0.5 to 4.5 micrometers. Thus, some of these allergenic portions are small enough to reach the lower airway regions and cause clinical symptoms associated with seasonal asthma.

Moisture (from raindrops or high humidity, for example) may cause other pollen grains to burse, releasing their allergenic portions plus starch. In fact, it is thought that thunderstorms may increase the concentration of pollen grains as well as their allergenic effects.

Pollen grains have many identifiable characteristics. For example, many pollen grains are colored, and many are electrically charged, although the magnitude and sign of electric charge may not be consistent among individual grains of a particular plant species. Some pollen grains, especially viable pollen grains, fluoresce upon being illuminated with ultraviolet radiation.

In view of the foregoing, what are needed are apparatus and methods that utilize inherent features and characteristics of particulate matter pollutants to optimize analysis and identification of the same. Further what are needed are portable apparatus and methods for quickly assessing and comparing physical characteristics and properties of sensed particulate matter with known sources of a variety of species of particulate matter. Optimally, such apparatus and methods may be used in a variety of external environments, may accurately identify the particulate matter, and may quickly and easily release the particulate matter from the device after identification to facilitate further immediate use. Such apparatus and methods are disclosed and claimed herein.

### BRIEF DESCRIPTION OF THE DRAWINGS

In order that the advantages of the invention will be readily understood, a more particular description of the invention briefly described above will be rendered by reference to specific examples illustrated in the appended drawings. Understanding that these drawings depict only typical examples of the invention and are not therefore to be considered limiting of its scope, the invention will be described and explained with additional specificity and detail through the use of the accompanying drawings, in which:

FIG. 1 is a comparative graph of particulate size ranges for aerosols and other particulate matter;

FIG. 2 is a magnified image of pollen grains from a variety of common plants;

FIG. 3 is a high-level block diagram of an apparatus for analyzing and identifying sensed particulate matter in accordance with embodiments of the invention;

FIG. 4 is a high-level block diagram of a portable electronic communication device having a microscope integrated therein in accordance with certain embodiments of the invention;

FIG. 5 is a high-level block diagram of a portable electronic communication device having a spectrometer integrated therein in accordance with certain embodiments of the invention;

FIG. 6 is a graph showing an exemplary transmission spectrum produced in connection with embodiments of the present invention;

FIG. 7a is a top view of a collection area utilizing a positioning element in accordance with one embodiment of the invention;

FIG. 7b is a side cutaway view of the collection area and positioning element of FIG. 7a;

FIG. 8a is a top view of a collection area utilizing a positioning element in accordance with another embodiment of the invention;

FIG. 8b is a side cutaway view of the collection area and positioning element of FIG. 8a;

FIG. 9a is a top view of a collection area utilizing a positioning element in accordance with a third embodiment of the invention;

FIG. 9b is a side cutaway view of the collection area and positioning element of FIG. 9a;

FIG. 10a is a perspective view of a collection area enabling identification of particulate matter in motion in accordance with certain embodiments of the invention;

FIG. 10b is a cutaway perspective view of the collection area of FIG. 9a;

FIG. 11 is a high-level block diagram of an interferometer that may be used in accordance with certain embodiments of the invention; and

FIG. 12 is a schematic illustration of a method of photoacoustic examination that may be performed by an identification element in accordance with certain embodiments of the invention.

### DETAILED DESCRIPTION

The invention has been developed in response to the present state of the art, and in particular, in response to the problems and needs in the art that have not yet been fully solved by currently available methods and apparatus for interrogating and identifying sensed particulate matter. Accordingly, the invention has been developed to provide a novel apparatus and method for optimizing identification of sensed particulate matter. The features and advantages of the invention will become more fully apparent from the following description and appended claims and their equivalents, and also any subsequent claims or amendments presented, or may be learned by practice of the invention as set forth hereinafter.

In one embodiment, an apparatus for analyzing and identifying sensed particulate matter includes a collection area attached to a portable electronic communication device, such as a cellular telephone. The collection area receives particulate matter from the external environment. A positioning element positions the particulate matter within the collection area to optimize placement of the particulate matter for optical inspection. An identification element illuminates and inspects the particulate matter to harvest data therefrom. The data includes, for example, optical characteristics of the particulate matter in a micrometer range. Finally, a software element compares the data to a library of stored data associated with various sources of particulate matter. The origin of the particulate matter under test is identified based on the comparison.

In another embodiment, a method for analyzing and identifying sensed particulate matter includes providing a portable electronic communication device having a substantially transparent collection area coupled thereto. Particulate matter is drawn from the external environment into the collection area. The particulate matter is positioned within the collection area to optimize its placement for inspection. The particulate matter is illuminated and inspected to harvest data therefrom. The data may include optical and/or photoacoustic characteristics of the particulate matter. The data is compared to a library of stored data associated with various sources of particulate matter. An origin of the particulate matter under test may be identified based upon the comparison.

It will be readily understood that the components of the present invention, as generally described and illustrated in the Figures herein, could be arranged and designed in a wide variety of different configurations. Thus, the following more detailed description of the embodiments of apparatus and methods in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As used herein, the term “aerosol” is used to refer to a colloid of fine solid particulates or liquid droplets, in air or in another gas. Examples include pollen, dust (such as cement dust or coal dust), cloud droplets, flour, coal fly ash, certain bacteria, fungal spores, and certain thoracic and respirable particulates. The term “optical” refers to any form of electromagnetic radiation such as visible light, infrared illumination, radio-frequency radiation, ultraviolet light, and the like.

Embodiments of the present invention collect and identify various species of particulate matter. In some embodiments, the particulate matter may be dispersed in air or another gas, forming an aerosol that may be drawn into a collection device from an external environment, such as an outdoor space or interior room. In other embodiments, the particulate matter may be dispersed in a solid or liquid, forming a colloid that may be deposited on a surface of the collection device. In some embodiments, particulate matter dispersed in a gas or liquid may be streamed through a collection area of the device so that particulates may be examined while in flight, moving substantially freely within the gas or liquid. In any case, embodiments of the present invention capitalize on the unique physical characteristics of various species of particulate matter to efficiently and accurately analyze and identify the particulate matter at issue.

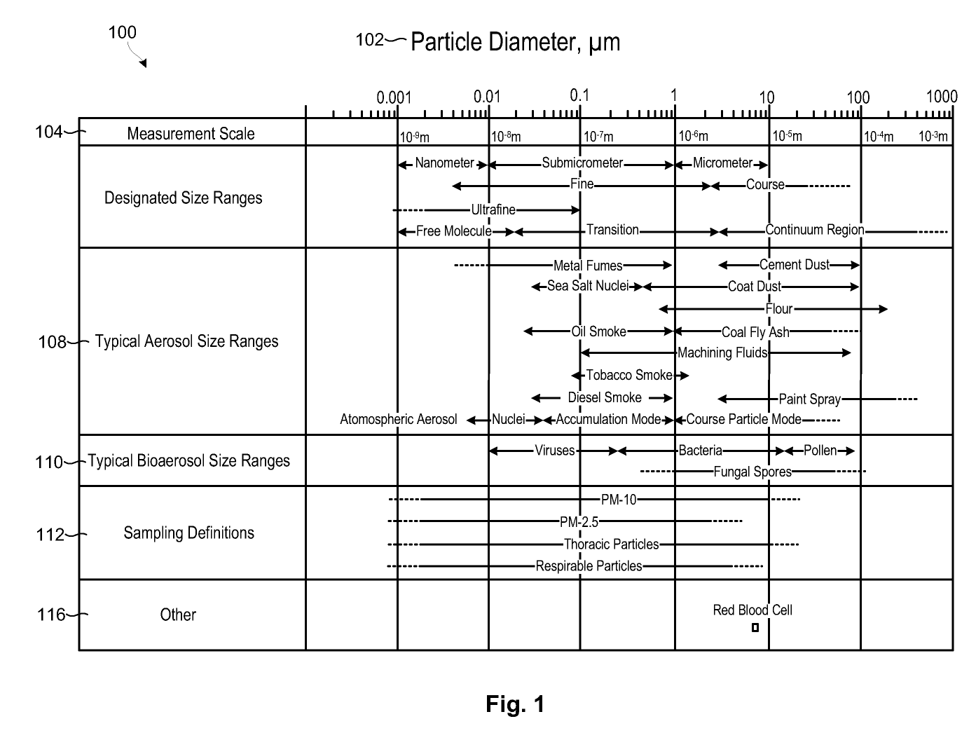

As shown in FIG. 1, particulate matter may be loosely organized according to particulate diameter 102. Even particulate matter that derives from a single species of origin, however, is rarely completely uniform in shape or particulate diameter 102. For this reason, FIG. 1 provides a precise measurement scale 104 with specific particulate diameters, while the remainder of the comparative graph 100 provides typical size ranges spanning a portion of such measurements that roughly correspond to various varieties of particulate matter.

Typical aerosol size ranges 108 include, for example, tobacco smoke (ranging from about 0.1 μm to about 1.0 μm), coal dust (ranging from about 1 μm to about 100 μm), and cement dust (ranging from about 5 μm to about 100 μm). Typical bioaerosol size ranges 110 include viruses (ranging from about 0.01 μm to about 0.4 μm), bacteria (ranging from about 0.4 μm to about 20 μm), and pollen, ranging from about 20 μm to about 100 μm.

Sampling definitions 112 are also provided as numerical ranges. As previously mentioned, particulate matter pollutants measuring 2.5 microns in diameter or less (PM_{2.5}) are particularly harmful to humans as they may penetrate deep into respiratory systems, and may even get into the bloodstream. Accordingly, as shown in FIG. 1, PM_{2.5} includes both thoracic particulates and respirable particulates. The “other” section 116 of the comparative graph 100 shows, for example, red blood cells measuring approximately 6-8 μm.

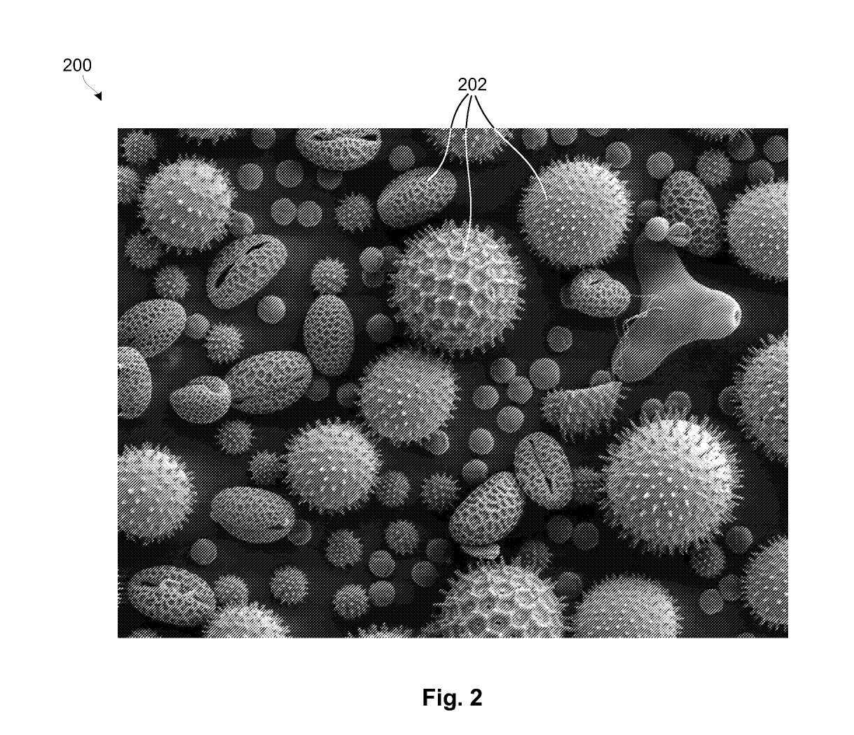

FIG. 2 demonstrates the variety of physical features and characteristics found within even a single category of particulate matter. Specifically, FIG. 2 is a scanning electron microscope image 200 of pollen grains 202 from common plants, including sunflower, morning glory, prairie hollyhock, oriental lily, evening primrose, and castor bean. As seen in the figure, while pollen grains 202 and other species of particulate matter are spoken of in terms of “diameter,” not all such pollen grains 202 are smooth or simply shaped. The sizes, colors, and chemical, electrical and other properties of pollen grains 202 and other particulate matter also vary dramatically. Embodiments of the present invention capitalize on these unique characteristics to quickly and accurately differentiate between species of pollen grains 202 and other particulate matter.

It is also noteworthy that while many whole pollen 202 grains are too large to be respired into lung airways or the tracheobronchial region, fragments of pollen grains, called subpollen particulates (“SPPs”) are capable of reaching the lower regions of the lung and causing clinical symptoms associated with seasonal asthma and severe allergic inflammation. Thus, embodiments of the present invention utilize a cumulative approach taking into account multiple physical features and properties to properly identify species of particulate matter. In this manner, embodiments of the invention may avoid misidentification of, for example, subpollen particulates that do not match an anticipated particulate diameter range associated with their whole pollen grain 202 counterparts. This cumulative approach is vital to enabling accurate identification of particulate matter, and may enable those prone to seasonal asthma, allergies, and other maladies to avoid areas or environments where the risk of exposure is high.

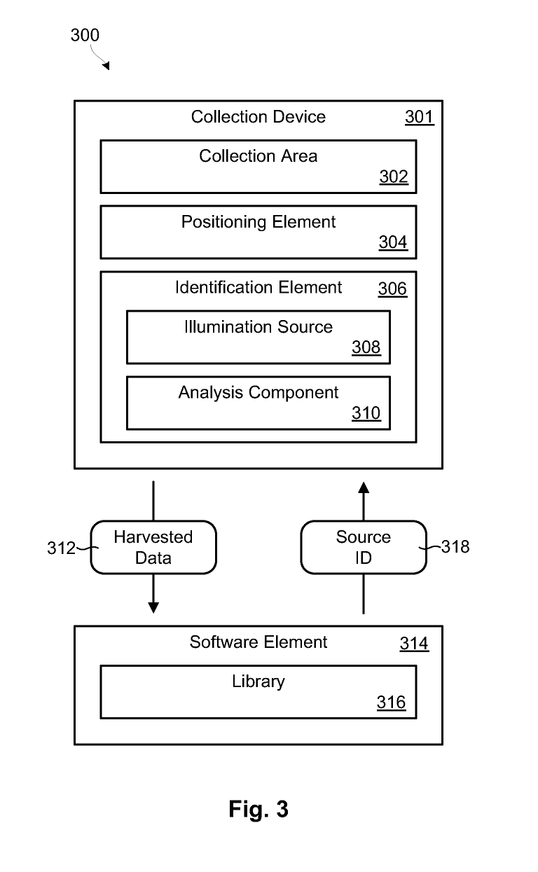

Referring now to FIG. 3, an apparatus 300 for analyzing and identifying sensed particulate matter in accordance with embodiments of the present invention may include a collection device 301 including a collection area 302, a positioning element 304, and an identification element 306.

The collection area 302 may be integrated with or attached to a portable communication device, such as a cellular telephone, personal digital assistant, tablet computer, wearable computing device, or the like. The collection area 302 may include a substantially transparent surface, channel, duct, tube, or other such area to receive particulate matter from an external environment and permit optical inspection and observation. In one embodiment, for example, the collection area 302 may include a portion or surface of an external housing or case containing internal components and circuitry of a portable electronic communication device. In certain embodiments, the collection area 302 may be substantially transparent and made of transparent glass, plexiglass, crystal, plastic, or other such material known to those in the art.

Particulate matter may settle onto the collection area 302 by gravity, or may be directly applied or deposited thereon. In some embodiments, particulate matter may include solid or fluid chemicals, bodily fluids, components of exhaled breath, or the like. Such fluids, such as a thin layer of blood, may be smeared onto the collection area 302 or deposited by liquid dropper, while other types of particulate matter may be passively or actively directed toward the collection area 302 by any means known to those in the art.

In some embodiments, particulate deposition onto the collection area 302 may be facilitated by thermophoresis, electrophoresis, or impaction. For example, in one embodiment, the collection area 302 may include a thermophoretic heater that produces a thermophoretic force to deflect particulate matter toward a collection surface. The thermophoretic heater may be, for example, a heated plate situated across from, or otherwise in proximity to, the collection surface. In other embodiments, the thermophoretic heater may be a wire, a series of wires, a substrate with a conductive coating, or any other suitable material known to those in the art.

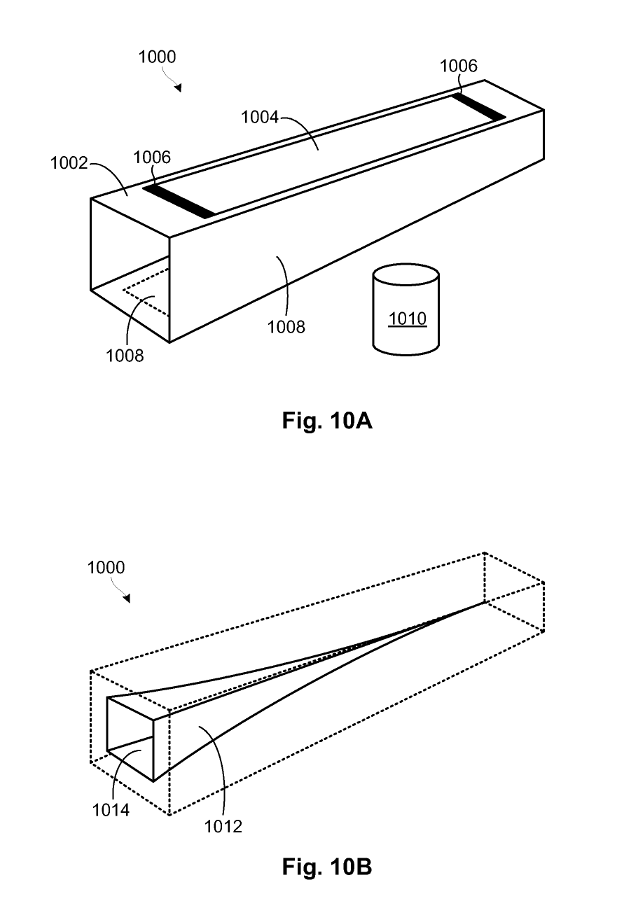

A positioning element 304 may also implemented in accordance with embodiments of the invention to optimize placement of the particulate matter for optical inspection. For example, as discussed in more detail below, the positioning element 304 may include energized electrodes that exert forces on particulates to move them into position for image taking. In another embodiment, the positioning element 304 may include means for moving particulate matter ultrasonically for image positioning and observation. Finally, in a third embodiment, the positioning element 304 may include transparent heaters integrated into or coupled to a transparent channel-like collection area 302 to condense a stream of particulate matter and move the stream into the focal plane of a microscope or camera system. In this manner, as discussed in more detail with reference to FIG. 10 below, the positioning element 304 may permit viewing of the particulate matter while in motion through the collection area 302.

In certain embodiments, the positioning element 304 may further function as a release element to selectively release collected particulate matter from the collection area 302 after analysis. For example, small particles (e.g., 0.1 micrometers in diameter and less) tend to be firmly held on surfaces that they contact due to van der Waals force, electrostatic forces, and forces arising from the surface tension of adsorbed liquid films. Various embodiments of positioning elements 304 may be implemented to minimize these attractive forces to permit particulate removal and facilitate immediate reuse of the collection device 301.

Effective particulate removal may involve some or all of the following: (1) limiting the amounts of liquids at a contact or supporting surface of the collection area 302 by wiping, for example; (2) lowering the humidity of the ambient atmosphere by heating; (3) utilizing a supporting surface in the collection area 302 that absorbs moisture into its interior and away from its surface; (4) roughening the surface by coating the surface with vertically or horizontally oriented nanotubes or nanowires; (5) chemically etching the surface; (6) imprinting a roughening pattern on the surface to reduce the contact area; and (7) ultrasonically agitating the supporting surface.

Sliding or rolling particulates from a supporting surface may be more effective at removal than application of a force normal to the surface. In addition, particulate/surface bonding strength tends to increase with duration of contact, so it may be beneficial to use the positioning element 304 for release substantially immediately after particulate contact, and possibly particulate identification. Further, certain particles of interest, such as some pollen grains, have shapes that depart significantly from spherical (e.g., some pollen grains have “spikes” on their outer surfaces). Such shapes may limit their area of contact on a flat supporting surface contact area and hence reduce the strength of particulate/surface adhesion. Accordingly, in certain embodiments, a positioning element 304 may include a piezoelectric ultrasonic transducer that may be used promptly to initiate vertical or sideways-directed vibration.

Many types of pollen grain can naturally become electrically charged. To the extent that they retain their charge when in light contact with the collection area 302, they may be driven away from the surface (after their measurement) by application of a like electric charge on the collection area 302 surface. Analogously, magnetized particulates might be driven away from a supporting surface of the collection area 302 by a positioning element 304 comprising an energized electromagnet.

In other embodiments, a positioning element 304 may include a heating element. Heating of the surface may exert a thermophoretic force on attached particulates, and so might cause some particulates to be driven from the surface. With strong heating particulates located on a supporting surface of the collection area 302 may vaporize. In some cases, such as where there is simple gravitational settling of particulates opposite the optical window of a camera, the collection area 302 may be simply wiped clean with a lens cleaning tissue. Similarly, a positioning element 304 may perform ultrasonic pumping with surface or Lamb waves to effectively remove particulates from the collection area 302 by laterally sliding them along its surface.

An identification element 306 may communicate with the collection area 302 to harvest data 312 from the particulate matter received. Particularly, the identification element 306 may include an illumination source 308 to illuminate the particulate matter, and an analysis component 310 to inspect the particulate matter and harvest the data 312 therefrom.

As discussed in more detail below, in some embodiments, the illumination source 308 may illuminate the collected particulate matter with visible light to facilitate direct observation. In other embodiments, the illumination source 308 may illuminate the collected particulate matter with light in other wavelength ranges including, for example, infrared light to determine constituents of the particulate matter illuminated, and/or ultraviolet light to cause the particulate matter to fluoresce.

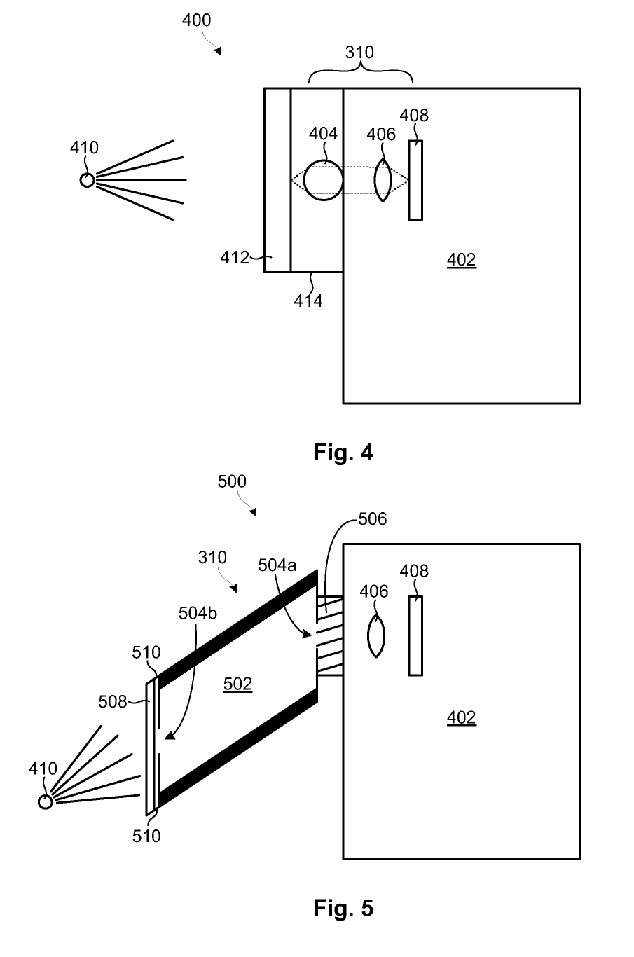

In some embodiments, the analysis component 310 may utilize optical detectors and photoreceptive devices such as microscopes, spectrometers, and/or cameras to inspect the collected particulate matter. As discussed in more detail with reference to FIG. 4 below, in some embodiments, a microscope may be provided by attaching a tiny spherical lens (such as a 1 mm ball lens) to the optical system of a camera integrated into a portable electronic communication device, such as a cellular telephone. This lens may facilitate optical inspection of collected particulate matter, while the camera may be utilized to capture the magnified image.

In other embodiments, as discussed in more detail with reference to FIG. 5 below, a spectrometer may be provided by attaching a diffraction grating and collimating tube to a camera of a portable electronic communication device to enable the device to measure properties of light over a specific portion of the electromagnetic spectrum. These properties may be used to facilitate particulate matter identification, as different materials generate different spectra of light. The camera may capture the spectral image. Of course, other optical detectors and/or photoreceptive devices known to those in the art may also be implemented in connection with embodiments of the invention.

In still other embodiments, the analysis component 310 may weigh and/or measure the particulate size of collected particulate matter. For example, in one embodiment, the analysis component 310 includes a mass-sensitive element to determine mass concentration of the collected particulate matter. In some embodiments, the mass-sensitive element is co-located with or doubles as a supporting surface of the collection area 302.

Oscillation frequency of the mass-sensitive element may decrease in proportion to the mass of particulates that reach and adhere to it. Before particulates are collected onto it, the mass-sensitive element may oscillate within a substantially high frequency range (i.e., around 1.6 GHz). If the mass-sensitive element has a coating to reduce its dependence of resonant frequency upon temperature, the resonant frequency may instead be around 600 MHz. In any case, as particulates are deposited onto the mass-sensitive element, the frequency at which it oscillates may decrease proportionally. The mass concentration of the particulates may be determined based on the rate at which the oscillation frequency of the mass-sensitive element is reduced.

In other embodiments, the analysis component 310 may examine the particulate matter to harvest data 312 regarding particulate matter size, shape, volume, mass, color, number (quantity), compactness, fluorescence, chemical properties (e.g., solubility), and/or biochemical properties (e.g., growth response to a nutrient), and other such information known to those in the art.

In some embodiments, the analysis component 310 may further perform image post-processing on harvested data 312 to automatically count and/or size individual particulates and obtain other information known to those in the art.

This data 312 may be used, in combination with other harvested data 312, to facilitate particulate matter identification. Specifically, in certain embodiments, harvested data 312 may be forwarded from the identification element 306 to a software element 314. The software element 314 may be co-located or wirelessly accessed from the collection device 301 of the present invention.

The software element 314 may include a library 316 of stored data associated with various sources of particulate matter. In some embodiments, the library 316 may include compilations of properties that can be used to identify origins of various particulate matter species. These may include, for example, infrared spectra and photoacoustic spectra, in addition to information regarding particulate matter size, shape, volume, mass, color, number (quantity), compactness, fluorescence, chemical properties (e.g., solubility), and/or biochemical properties (e.g., growth response to a nutrient), and other such properties and optical features and characteristics known to those in the art.

Upon comparison, the software element 314 may identify an origin or source 318 of the subject particulate matter. In some embodiments, this source identification 318 may be returned to the collection device 301 for output to a user. In other embodiments, the source identification 318 may be retained by the software element 314 for further reference and/or processing.

Referring now to FIG. 4, one embodiment of an apparatus 400 in accordance with the present invention may include a portable electronic communication device 402, such as a cellular telephone, personal digital assistant, tablet computer, wearable computing device, or the like, equipped with optically responsive elements such as a camera lens 406 and complementary metal-oxide-semiconductor (“CMOS”) sensor 408, for example. Such optically responsive elements may comprise the identification element 306 of the apparatus 400.

The camera system 406, 408 of the device 402 may be further modified to provide an analysis component 310 comprising a microscope. As shown, a small ball lens 404 may be mounted directly onto an external window of the camera system of the portable electronic communication device 402. In some embodiments, the ball lens 404 may be mounted to the portable electronic communication device 402 by way of a rubber ring and double-sided tape, for example, or by any other means known to those in the art. The external location of the ball lens 404 may substantially correspond to the internal location of the camera lens 406 and CMOS sensor 408.

A collection area 412 may be placed in the plane of best focus relative to the ball lens 404. In certain embodiments, the collection area 412 may be attached to the portable electronic communication device 402 at a location substantially corresponding to, but at least slightly distal from, the ball lens 404. Attachment of the collection area 412 to the portable electronic communication device 402 may be achieved by attachment means 414 such as adhesive, mechanical fasteners, or by any other suitable means known to those in the art.

Illumination may be achieved by means of a white-light LED or other suitable light source 410 known to those in the art. In some embodiments, the light source 410 may be substantially covered by a low-grade diffuser, such as a piece of matte-finished adhesive tape. The light source 410 may be placed at a distance from the collection area 412, where the distance may be selected to achieve approximately collimated illumination across the field-of-view of the microscope.

In some embodiments, as mentioned above, the identification element 306 may further include software to perform image post-processing and automatically produce information about the captured image. For example, the software program CellC™ may be implemented to automatically count individual particulates, calculate particulate dimensions such as width and length, approximate the volume of individual particulates, and estimate the solidity and compactness of each.

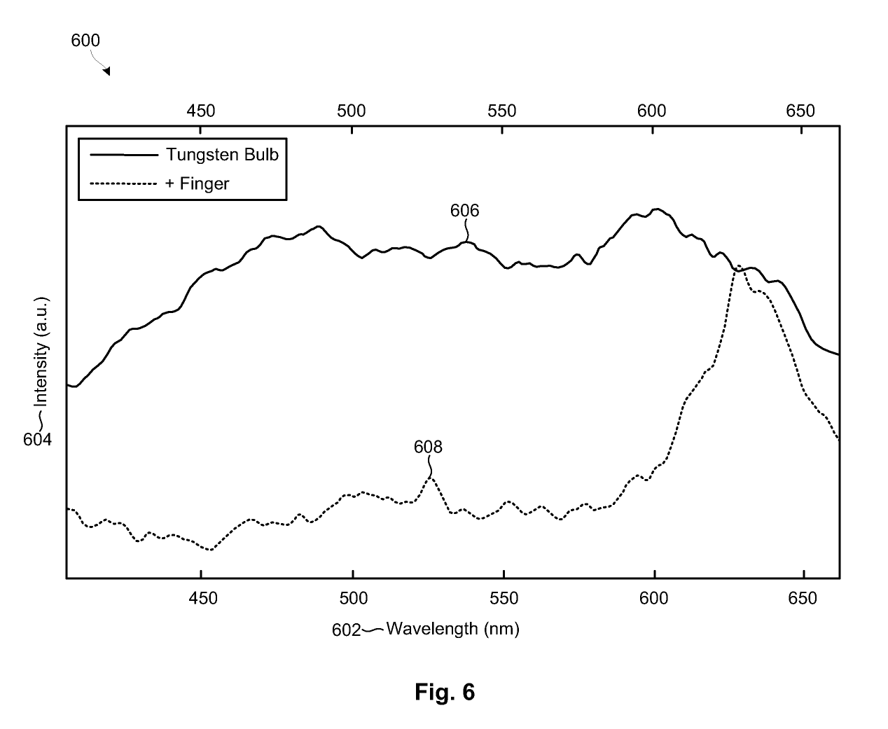

Referring now to FIGS. 5 and 6, other embodiments of an apparatus 500 in accordance with the invention may include an identification element 306 adapted to perform optical spectroscopy and record a transmission spectrum 600 associated with a particulate matter sample. To this end, a portable electronic communication device 402 may be equipped with a spectrometer to measure properties of light over a specific portion of the electromagnetic spectrum. These properties may be used to identify the particulate matter at issue.

In one embodiment, a spectrometer may be constructed by affixing a transmission grating 506 over a window corresponding to a camera lens 406 and CMOS sensor 408 of the portable electronic communication device 402. The transmission grating 506 may be attached to a collimating tube 502 having small slits 504a, 504b disposed in either end. The transmission grating 506 and collimating tube 502 may be attached to or integrated with a surface of the portable electronic communication device 402 with adhesive, fasteners, or by any other suitable attachment means known to those in the art.

In one embodiment, two pieces of black electrical tape may be placed over the grating 506 to form a slit 504a of approximately 1 mm in width. The collimating tube 502 may include a piece of PVC tubing, cut at a 45° angle and lined with darkened foil to prevent inner reflections. Another slit 504b substantially mirroring the first slit 504a may be formed at the distal end of the collimating tube 502 using, for example, another two pieces of black electrical tape. The collimating tube 502 in combination with the slits 504a, 504b may ensure that only approximately collimated light passes to a detector (not shown) residing within the portable electronic communication device 402.

To measure light transmission through a particulate matter sample, the collection area 508 may be attached to the collimating tube 502 at a location substantially corresponding to, but at least slightly distal from, its distal end. Attachment of the collection area 412 to the collimating tube 502 may be achieved by an attachment element 510, such as an optical aperture, or any other suitable attachment means known to those in the art. The distal end of the collimating tube 502 and associated collection area 412 may be pointed toward a light source 410, such as a 60 Watt tungsten bulb or the like. In some embodiments, the light source 410 may include a bright, narrowband, tunable arc source to facilitate measurements of fluorescence.

As shown in FIG. 6, the detector (not shown) may detect the light's intensity 604 relative to its wavelength 602, producing a transmission spectrum 600 for the sample. The transmission spectrum 600 may substantially uniquely correlate to a source of particulate matter, thereby facilitating identification of an unknown sample. In some embodiments, the transmission spectrum 600 may be recorded as an image by the associated camera system.

FIG. 6 illustrates exemplary transmission spectra 600 for an infrared source 606, and radiation from the same source as filtered through a human finger 608, respectively. Just as the two transmission spectra 600 of FIG. 6 are easily distinguishable from each other, transmission spectra 600 produced for various species of particulate matter may be compared to stored transmission spectra 600 to facilitate source identification.

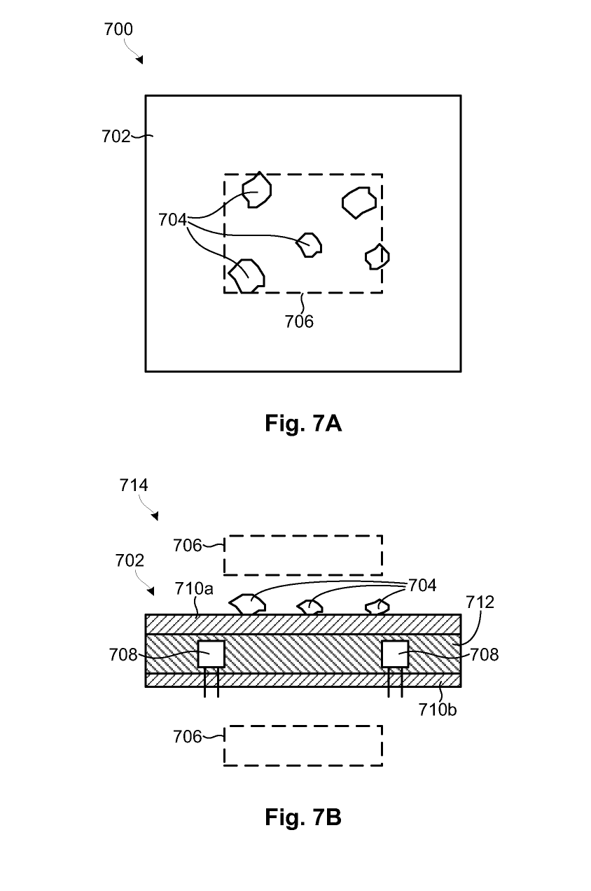

Referring now to FIGS. 7a and 7b, in some embodiments, a collection area 700 may include one or more substantially planar surfaces 702 to enable particulate matter 704 to settle or be purposefully disposed thereon. As previously mentioned, the collection area 700 may be substantially transparent to permit optical viewing and/or illumination from one or more external light sources 708.

As illustrated, such light sources 708 may include multiple small radiation sources, such as infrared and/or visible light LEDs, attached to a surface of a portable electronic communication or other collection device 714 at a location substantially corresponding to the collection area 700. In one embodiment, an external surface or casing of the collection device 714 may be substantially translucent such that the light sources 708 may be attached to or embedded within a surface of the device 714, while illumination from the sources 708 may shine through an external surface of the device 714 to illuminate a co-located exterior region. In some embodiments, the supporting surface 702 of the collection area 700 may include at least a portion of the surface of the collection device 714.

In certain embodiments, optical guiding may be used to control the distribution of illumination provided by the light sources 708. For example, light sources 708 (such as LEDs) may be embedded in a surface of the collection device 714. The housing or casing of the collection device 714 may include more than one layer. In some embodiments, for example, the collection device 714 casing may be deposited in a coating having an index of refraction lower than that of the underlying material for embedding the light sources 708.

In other words, the light sources 708 may be embedded in a relatively high index layer 712, which may form the bottom or middle layer of the overall casing structure. A low index optical film 710a may substantially overlie the high index layer 712, providing a low index of refraction for optical guiding. In some embodiments, the low index optical film 710a, 710b may be disposed on either side of the high index region 712, such that the high index region 712 is substantially sandwiched between the two low index optical film layers 710a, 710b. A camera system 706 may reside above or below either or both surfaces 710a, 710b to capture illumination data from particulates collected onto the viewing surface 702 of the collection area 700.

In operation, the illustrated embodiment would allow for optical waveguiding to prevent the guided luminous energy from escaping from the body of the collection device 714 except in cases where a particulate 704 is in intimate contact with the outermost surface of the device 714, forming the supporting surface 702 of the collection area 700. In such locations, light that is otherwise losslessly transmitted in the topmost layer 710a will instead escape from the layer 710a and at least partially illuminate the captured particulate.

In other embodiments, particulate matter 704 collected onto the collection area 700 may receive brief pulses of illumination, while pixels of the camera 706 respond to the illumination to perform particulate counting and particulate velocity measurements. Alternatively, individual radiation detector arrays may be implemented as optical receivers. In any case, illumination changes may be detected that indicate the appearance of particulate matter 704 in the field of view. In this manner, embodiments of the invention may facilitate counting particulates and measuring the flow rate of particulates, and more generally, of the carrier gas or liquid. This may be useful in calibrating the apparatus for concentration measurements.

Further, the camera 706 and/or optical receiving array may detect reflected and/or emitted radiation originating from reflection, partial absorption, transmission, fluorescence, and the like, of the particulates. These measurements may facilitate a determination of the identity of the particulate matter 704.

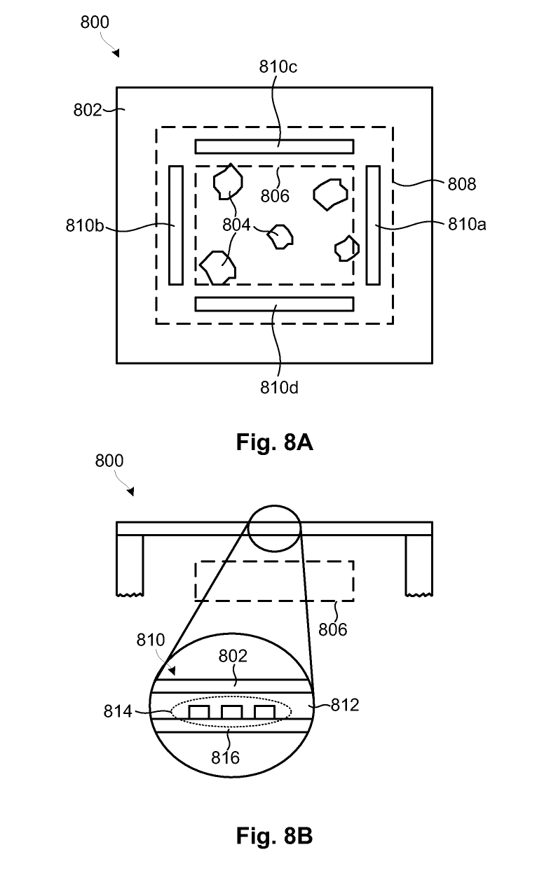

Referring now to FIGS. 8a and 8b, particulate matter 804 may accumulate or be deposited onto a supporting surface 802 of a collection area 800 in a location that is not optimal for inspection and analysis. In other cases, accumulated or deposited particulate matter 804 may need to be removed from the collection area 800 after identification. In either case, it may be beneficial to manipulate the particulate matter 804 over the surface 802 of the collection area 800 to a better field of view, or to release or remove the particulate matter 804 from the field of view altogether.

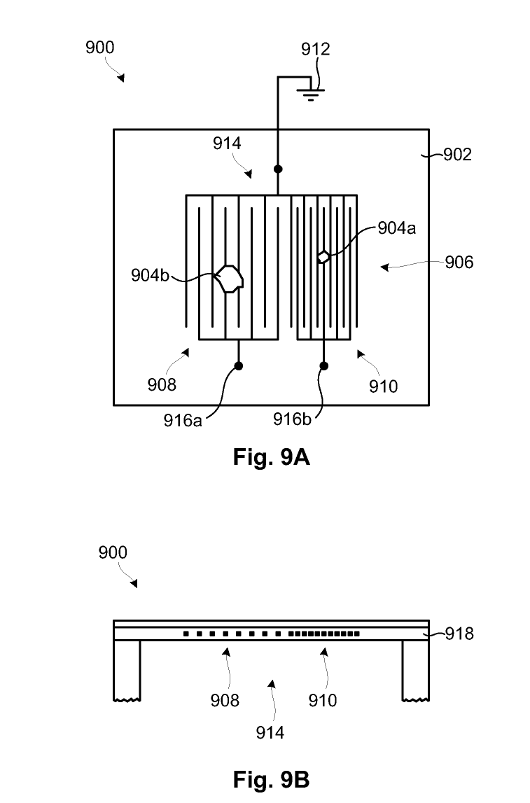

According to one aspect of the invention, a supporting surface 802 of a collection area 800 may be pumped with ultrasonic surface or Lamb waves to move particulates laterally along the supporting surface 802. The particulates may be dispersed and moved within a gas or liquid. In certain embodiments, as discussed in more detail below, movement of the particulates may be further focused by implementing carved electrodes 814 beneath the supporting surface 802. Alternatively, as discussed in more detail with reference to FIGS. 9a and 9b below, particulates may be moved along the supporting surface 802 with purely electrical forces.

As shown, the collection area 800 may include a substantially transparent supporting surface 802 to permit optical viewing and analysis. In some embodiments, the supporting surface 802 may be substantially smooth, planar, and integrated with or coupled to a portable electronic communication device (not shown). A camera 806 may reside above or below the supporting surface 802 to capture an image of the particulate matter 804 accumulated or deposited thereon for inspection and/or analysis.

The supporting surface 802 may include an acoustic region 808 to generate ultrasonic Lamb or surface acoustic waves to drive solid particulate matter 804 in a gas or liquid along the smooth supporting surface 802 in a desired direction. For example, the acoustic region 808 may include one or more positioning elements 810a-d to propagate ultrasonic surface or Lamb waves in opposite directions along the supporting surface 802. The direction of the propagated wave may move particulates 804 disposed on the surface 802 in the same direction.

As shown, a horizontally-placed positioning element 810c located near a top edge of the supporting surface 802 may move particulate matter 804 in a downward direction; a parallel-placed positioning element 810d located near a bottom edge of the supporting surface 802 may move particulate matter in an upward direction; a vertically-placed positioning element 810a located near a right edge of the supporting surface 802 may move particulate matter to the left; and a parallel-placed positioning element 810b located near a left edge of the supporting surface 802 may move particulate matter to the right.

In certain embodiments, as shown in FIG. 8b, particulate matter 804 may be more precisely positioned by moving it incrementally backwards and forwards along a linear path. To this end, a positioning element 810 may further include electrically driven (low voltage RF) interdigital transducer electrodes 814. Such electrodes 814 may be microfabricated on a sputtered layer of piezoelectric film 812 such as aluminum nitride, for example. A support layer 816 for the electrodes 814 may include any suitable material known to those in the art. Positioning particulate matter 804 in this manner may enable more focused and precise imaging, thereby facilitating more efficient and accurate identification. This may also facilitate faster processing times and throughput.

Referring to FIGS. 9a and 9b, in some embodiments, lightly attached particulate matter 904 may be moved about on a substantially smooth supporting surface 902 of a collection area 900 purely under the influence of potentials applied to suitably designed electrodes 908, 910. As mentioned previously, this embodiment of a positioning element 914 may also be used to put particulates 904 into motion to make them more susceptible to being removed by a flow of air above the surface, by vibration of the surface in a vertical direction, or by any other means known to those in the art. This removal process may essentially renew the supporting surface 902 for inspection of newly collected particulate matter 904.

As shown, the positioning element 914 may include arrays of electrodes 906 with dielectrophoresis effects. As in other embodiments, such electrodes 906 may be microfabricated on a sputtered layer of piezoelectric film 918 such as aluminum nitride, for example. The arrays 906 may be arranged such that one array is positioned substantially opposite the other, and each electrode of the first array is adjacent to an electrode of the second. In this manner, the electrodes may form an interlocking, or interdigitated, arrangement 906, with each array 906 connected to common ground 912.

The unique geometry and placement of the electrodes 906 can produce different configurations of dielectrophoresis waveforms. For example, some interdigitated electrodes 906 may be substantially widely spaced 908, while other interdigitated electrodes 910 may be substantially narrowly spaced. In other embodiments, electrodes 906 may include other configurations or shapes to move particulates 904a, 904b in a desired direction when excited. For example, electrodes 906 may be curved so as to focus and bunch particulates 904a, 904b on the supporting surface 902. Indeed, different spatial and/or geometric electrode arrangements may be desirable depending on the medium in which the particulate matter is dispersed, the particulates' shape and size, the particulates' electrical properties, and the frequency of the electric field. The resulting waveforms may allow manipulation of the strength and location of electric fields, such that particulate matter 904 collected on a supporting surface 902 of the collection area 900 may be incrementally manipulated in planar x- and y-positions.

In operation, conducting electrodes 906 on the supporting surface 902 may be activated by voltage sources connected to the electrodes 906 via a terminal 916a, 916b. When electrically energized, the electrodes 906 may produce electric fields between them and may thus exert a force on either electrically conducting or nonconducting particulates 904a, 904b, causing them to move along the surface 902. Electrically charged particulates 904, such as some pollens, may also be acted upon by the energized electrodes 906 such that their movement along the surface 902 may provide evidence of their state of charge.

Referring now to FIGS. 10a and 10b, some embodiments of a collection area 1000 enable observation of particulate matter 1014 while such particulate matter 1014 is in motion therethrough. As shown, for example, a collection area 1000 may include a substantially transparent rectangular duct 1002 having an internal channel 1012 to accommodate a flow or stream of particulate matter 1014 dispersed in a gas or liquid medium. Of course, those skilled in the art will recognize that the duct 1002 and internal channel 1012 are not limited to elongate or rectangular configurations, and may comprise any shapes or dimensions known to those in the art to accommodate a flow of particulate matter 1014 while it is in motion. Likewise, the duct 1002 and internal channel 1012 may be made of any suitable material including transparent glass, plexiglass, crystal, plastic, or other such material known to those in the art.

In certain embodiments, a fan or pump (not shown) may be connected to or situated adjacent to the duct 1002 to facilitate faster particulate matter 1014 sampling. In one embodiment, the collection device (not shown) or collection area 1000 may be mounted on or situated adjacent to an existing source of air flow, such as a filter of a furnace or HVAC system. For example, in embodiments where the collection device is located on the inflow side of a filter, a large airflow velocity (e.g., cubic meters of air per minute) may be obtained to facilitate the detection of pollen grains, whose concentration in ambient air can be quite small (e.g., tens to hundreds of grains per cubic meter).

The collection area 1000 may be further situated adjacent to a camera system or microscope 1010 that can resolve optical characteristics of the particulate matter 1014 in a micrometer range. In certain embodiments, as discussed above, the camera system or microscope 1010 may be integrated with or coupled to a portable electronic communication device (not shown) or other collection device known to those in the art. Compact light sources (not shown) such as visible, infrared, and/or ultraviolet radiation sources may be incorporated within or outside of the duct 1002 to illuminate particulate matter 1014 passing therethrough.

Since a microscope typically has a small depth of focus, it may be beneficial to confine a beam of small gas or liquid-driven particulates 1014 into a thin sheet located at an adjustable distance from the camera or microscope 1010 system. Further, it may be beneficial to keep particulates 1014 from adhering to the walls 1008 of the internal channel 1012 so as not to miss any collected particulates 1014 present in small amounts.

Accordingly, certain embodiments of the invention include substantially transparent electrical heaters 1004 applied to one or more walls 1008 of the internal channel 1012. The electrical heaters 1004 may include, for example, transparent electrically conducting films such as indium tin oxide, or any other suitable material known to those in the art. Voltages may be applied to the heaters 1004 by way of power supply electrodes 1006, and may be independently adjustable.

In this manner, for example, upper and lower wall surfaces 1008 may be set at temperatures T1 and T2, which are both higher than T0, the temperature of the entering aerosol or liquid colloid. Because of the thermophoretic effect associated with the wall heating, the heated upper and lower wall surfaces 1008 may exert downward and upward forces, respectively, on the particulate matter 1014, causing the particulates 1014 to be concentrated in the interior 1012 of the duct 1002. This may keep the particulates 1014 from becoming attached to the upper and lower walls 1008, as well as to the sidewalls 1008, which will arrive at a temperature between T1 and T2 and hence higher than T0, and thus cause some compression of the particulate matter 1014 stream in the transverse direction.

In some embodiments, a vertical positioning of the concentrated particulate matter 1014 stream may be adjusted by varying the voltages on the upper and lower walls 1008 in order to keep the particulate matter 1014 stream at the proper location for focusing the camera or microscope 1010, or other such optical analysis component known to those in the art.

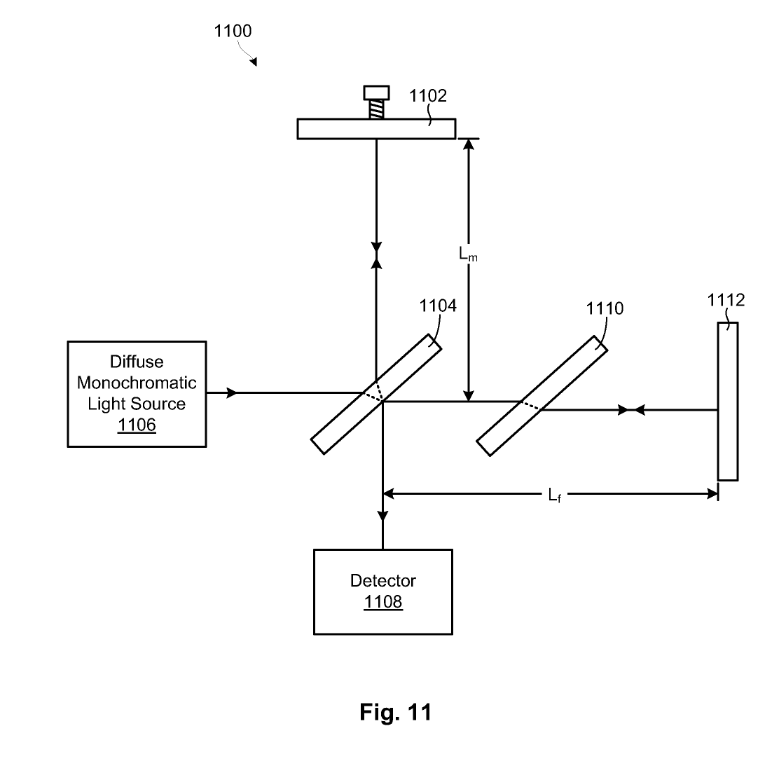

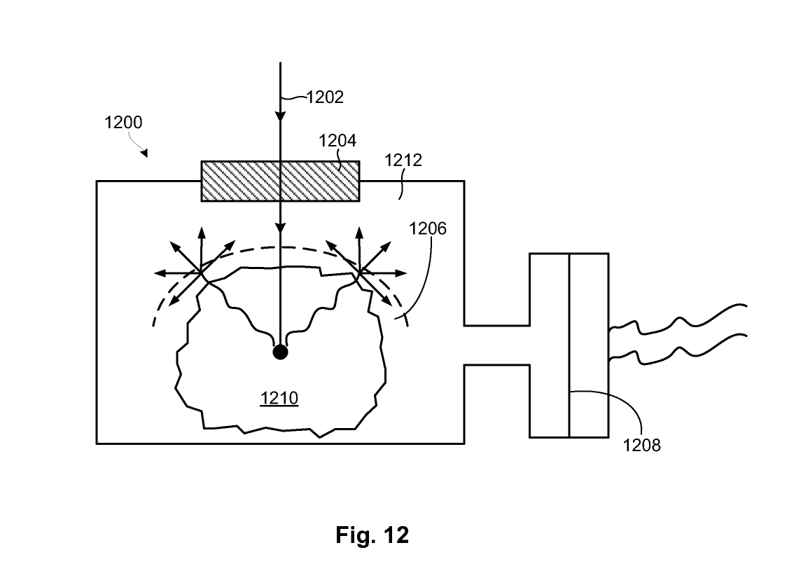

Referring to FIG. 11, some embodiments of the present invention may utilize infrared illumination to determine the composition of unknown particulate material. In the present context, an infrared radiation source such as an infrared LED or an infrared laser may be used, in which case the emitted infrared radiation may have a relatively narrow range of wavelength and the measurement of the infrared absorption of aerosol samples may be made via simple transmission and detection. Alternatively, if these radiation sources can be pulsed so as to emit radiation intermittently, in the interest of economy one may use photoacoustic spectroscopy to determine the infrared absorption spectrum, as illustrated later in FIG. 12.

As it is often of interest to make such determinations of infrared transmission rapidly, the so-called Fourier Transform Infrared Radiation (“FT-IR”) source, well known to those in the art, is often used. Generally, an FT-IR source includes the following elements: (1) a broadband radiative infrared source 1106, such as a heated filament or broadband infrared LED; (2) a special type of Michelson interferometer 1100 that includes one fixed mirror 1112 and one movable mirror 1102, where the movable mirror 1102 may be physically moved so as to produce a reflected beam that changes with time and interferes with the wideband beam reflected from the fixed mirror to produce a beam that shines on the substance under examination; (3) a detector 1108 that outputs the instantaneous amplitude of the radiation transmitted through the particulate matter under test; (4) a computer (not shown) that tracks the selected wavelengths as a function of time and performs a Fourier transform calculation to produce a spectrum of transmitted amplitude versus radiation wavelength; and (5) a measurement element (not shown) to measure the position (Lm) of the moving mirror 1102 at the time each measurement of the response of the infrared illumination is made.

In some cases, the measurement element takes an optical measurement (Lm) from a fixed point to the moving mirror 1102 using a laser-based standing-wave pattern. One way to do this is to modulate an auxiliary visible optical source, such as a laser pointer, and detector in an optical cavity whose resonance is controlled by the moving mirror 1102. From counting the number of resonant peaks of this auxiliary optical element, the position of the mirror at each instant can be determined for use in performing the FT-IR calculation to obtain the infrared absorption spectrum for use in particulate identification.

As the movable mirror 1102 moves, the emergent beam, which results from the interference of the beams reflected from the fixed mirror and from the moving mirror, contains all the wavelengths produced by the source. In order to obtain transmission versus wavelength, the Fourier transform of the output is calculated with an auxiliary computer, and this produces the desired infrared transmission spectrum.

Most commercially available FT-IR sources are not suitable for use in connection with the present invention as they tend to be both large and expensive. As an alternative to currently available FT-IR sources, a thin lightweight mirror 1102 may be mounted on the center of a device that can move to change the wavelengths of the output from the interferometer 1100. Suitable devices that could support the moving planar mirror may include the cone of a small conventional voice-coil-driven loudspeaker, a planar piezoelectric vibrator (i.e., buzzer) that can be driven by a low-frequency voltage source, or a piezoelectric disk that is similarly driven. Of course, one skilled in the art will recognize that is important that the mirror 1102 not depart from planar when it is moved.

Referring now to FIG. 12, some embodiments of the invention may utilize photoacoustic spectroscopy to determine the identity and concentration of particulate matter 1210 in a solid, gas or liquid. This type of analysis may involve shining pulses of swept-frequency optical illumination 1202 (i e, infrared light) through a window 1204 onto particulates 1210 contained on a supporting surface 1212 of a gas-filled chamber 1200. The light 1202 may be partially absorbed as it propagates through the particulates 1210, causing localized heating. The thermal disturbance may propagate at a low velocity toward the boundaries 1206 of the particulate matter 1210, producing an acoustic wave in the chamber 1200 that is detectable by microphone 1208. This may also be detected as a time-varying pressure in the gas that is contact with the sample 1210.

In embodiments where the supporting surface 1212 is a mass-sensitive element such as a piezoelectric crystal or FBAR oscillator, this variance in pressure may be detected by the mass-sensitive element, which may produce a photoacoustic absorption spectrum from which the identity of the particulate matter 1210 can be determined. Indeed, since the absorption spectrum of the pulsed illumination 1202 varies with the substance 1210 illuminated, the composition of the particulates 1210 may be identified based on the photoacoustic spectrum produced by the mass-sensitive element.

In other embodiments, the acoustic wave produced in the chamber 1200 may be detected with a small, audio-frequency microphone 1208 employing a piezoelectric, electret, or micromechanical transducing mechanism. In this manner, amplitude vs. radiation wavelength data may be obtained in the form of a measured spectrum that may be compared with spectra stored in a spectra library in the software element (not shown). By measuring the phase of the detected audio output relative to that of the incident radiation, spectra of even the individual layers of such a particulate matter 1210 sample may be obtained for samples up to about 100 micrometers thick. This feature may prove useful as multilayer samples may include more than one identifiable source.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for analyzing and identifying sensed particulate matter, the apparatus comprising:
a collection area coupled to a portable electronic communication device to receive particulate matter from an external environment;
a positioning element to position the particulate matter within the collection area to optimize its placement for optical inspection;
an identification element communicating with the collection area, comprising an illumination source to illuminate the particulate matter and an analysis component to inspect the particulate matter and harvest data therefrom, the data comprising optical characteristics of the particulate matter in a micrometer range; and
a software element communicating with the identification element to compare the data to a library of stored data associated with various sources of particulate matter, and to identify an origin of the particulate matter based upon the comparison.

2. The apparatus of claim 1, the analysis component further comprising a mass-sensitive element, wherein a resonant frequency of the mass-sensitive element is reduced in proportion to the mass of the particulate matter collected.

3. The apparatus of claim 2, wherein the mass-sensitive element comprises a piezoelectric crystal.

4. The apparatus of claim 2, wherein the data further comprises the resonant frequency of the mass-sensitive element.

5. The apparatus of claim 1, wherein the collection area further comprises one of a thermophoretic element and an electrophoretic element to facilitate particulate matter deposition thereon.

6. The apparatus of claim 1, wherein the collection area comprises a channel to receive a stream of the particulate matter in motion.

7. The apparatus of claim 6, wherein the collection area further comprises a substantially transparent heater coupled to at least one wall of the channel.

8. The apparatus of claim 1, wherein the illumination source comprises at least one of an infrared LED, a visible LED, an ultraviolet LED, an infrared laser, and an incandescent lamp.

9. The apparatus of claim 8, wherein the illumination source is deposited in a coating having an index of refraction lower than that of the material in which the illumination source is installed.

10. The apparatus of claim 1, wherein the analysis component comprises one of a camera and a microscope.

11. The apparatus of claim 1, wherein the analysis component further harvests data comprising a level of infrared absorption of the particulate matter.

12. The apparatus of claim 1, wherein the analysis component further harvests data comprising a photoacoustic spectroscopy spectrum of the particulate matter.

13. The apparatus of claim 1, wherein the positioning element further selectively releases the particulate matter from the collection area.

14. A method for analyzing and identifying sensed particulate matter, the method comprising:
providing a portable electronic communication device having a substantially transparent collection area coupled thereto;
drawing particulate matter from an external environment into the collection area;
positioning the particulate matter within the collection area to optimize placement for inspection;
illuminating the particulate matter;
inspecting the particulate matter to harvest data therefrom, the data comprising at least one of optical and photoacoustic characteristics of the particulate matter;
comparing the data to a library of stored data associated with various sources of particulate matter; and
identifying an origin of the particulate matter based upon the comparison.

15. The method of claim 14, wherein inspecting the particulate matter comprises inspecting the particulate matter while it is in motion through the collection area.

16. The method of claim 14, wherein positioning the particulate matter comprises at least one of applying an electric field to the collection area, ultrasonically pumping the collection area, and photoconductively guiding the particulate matter in the collection area.

17. The method of claim 14, wherein inspecting the particulate matter further comprises sizing the particulate matter by one of impaction, camera and image post-processing, weighing, and filtering.

18. The method of claim 14, wherein the data further comprises at least one of chemical and biological characteristics.

19. The method of claim 14, further comprising selectively releasing the particulate matter from the collection area.

20. The method of claim 19, wherein selectively releasing the particulate matter comprises at least one of vibrating the collection area, applying one of an electric, magnetic, and thermal field to the collection area, vaporizing the particulate matter, wiping the collection area, and propagating ultrasonic waves to release the particulate matter from the collection area.
